(19) United States
(12) Patent Application Publication
(10) Pub. No.: US 2024/0047920 A1
(43) Pub. Date: Feb. 8, 2024

(54) High-Voltage Connector Device

(71) Applicant: Connecteurs Electriques Deutsch, Evreux (FR)

(72) Inventors: Thierry Cassar, Evreux (FR); Simon Delaire, Evreux (FR); Jacques Romanillos, Evreux (FR); Baptiste Vaullerin, Evreux (FR)

(73) Assignee: Connecteurs Electriques Deutsch, Evreux (FR)

(21) Appl. No.: 18/364,532

(22) Filed: Aug. 3, 2023

(30) Foreign Application Priority Data
Aug. 3, 2022 (EP) 22306173.0

(51) Int. Cl. H01R 13/53; H01R 13/514

(52) U.S. Cl. CPC H01R 13/53; H01R 13/514

(57) ABSTRACT

A connector device for connecting a cable includes a housing and a contacting element. The housing has a cover formed of a dielectric cover wall material and a base formed of a dielectric base wall material. The cover and the base are mated in a closed state of the housing and receive an end portion of the cable that has an electrically conductive portion. The contacting element electrically contacts the electrically conductive portion of the cable in the closed state of the housing. The housing is substantially gas-free in the closed state between the electrically conductive portion of the cable and the dielectric cover wall material, the electrically conductive portion of the cable and the dielectric base wall material, the contacting element and the dielectric cover wall material, and the contacting element and the dielectric base wall material.

### CROSS-REFERENCE TO RELATED APPLICATION

This application claims the benefit of the filing date under 35 U.S.C. § 119(a)-(d) of European Patent Application No. 22306173.0, filed on Aug. 3, 2022.

### FIELD OF THE INVENTION

The invention relates to connector devices configured for connecting electric cables, particularly, in high-voltage applications. The connector devices may be configured for connecting individual cables with each other or may be connector terminations for connection to some appliances.

### BACKGROUND

Connectors for connecting electrical cables for transporting electrical currents are ubiquitous. Reliable connection of one or more electrical cables to a connector or to one or more other electrical cables, in particular, in harsh environments and high-voltage applications poses demanding problems in the context of a great variety of applications including, for example, aerial and automotive applications.

A particular problem arising in the context of connecting electrical cables is the occurrence of the so-called triple point or triple junction. The triple point is a junction between a conductor, a solid dielectric, and a gaseous dielectric, and there is a high risk that connection failure is caused by such a triple point. A prominent example is illustrated in FIG. 1 that shows an electrical cable comprising an inner electrical conductor or conductor strands 1010 insulated by a dielectric material 1020. An electrical conductive braid 1030 is formed on the dielectric material 1020. The presence of air 1040 together with the conductor 1010 and the braid 1030, respectively, and the dielectric material 1020 gives raise to the formation of the triple point 1050. Particularly, in high-voltage applications, discharge events may occur at the triple point leading to malfunction. Therefore, triple points must be avoided in electrical connections, in particular, at connector interfaces.

### SUMMARY

A connector device for connecting a cable includes a housing and a contacting element. The housing has a cover formed of a dielectric cover wall material and a base formed of a dielectric base wall material. The cover and the base are mated in a closed state of the housing and receive an end portion of the cable that has an electrically conductive portion. The contacting element electrically contacts the electrically conductive portion of the cable in the closed state of the housing. The housing is substantially gas-free in the closed state between the electrically conductive portion of the cable and the dielectric cover wall material, the electrically conductive portion of the cable and the dielectric base wall material, the contacting element and the dielectric cover wall material, and the contacting element and the dielectric base wall material.

### BRIEF DESCRIPTION OF THE DRAWINGS

The invention is explained in more detail below with reference to schematic figures, of which:

FIG. 1 is a schematic diagram of the triple point problem to be addressed in the present application;

FIG. 2 is a perspective view of an electrical cable that can be connected by an electrical connector device presented herein;

FIG. 3A is a perspective view of a cover and a base of a housing of a connector device in a mated open state;

FIG. 3B is a perspective view of the cover and the base of the housing of the connector device in a mated closed state;

FIG. 4 is a perspective view of a termination connector device for connecting electrical cables to a connector;

FIG. 5A is a perspective view of a cover of a housing of a connector device according to an embodiment;

FIG. 5B is a perspective view of a base of the housing of the connector device;

FIG. 6 is a sectional side view of two cables inserted in the cover and the base of FIGS. 5A and 5B;

FIG. 7A is a detail schematic side view of latching in FIG. 6;

FIG. 7B is a detail schematic perspective view of latching in FIG. 6;

FIG. 8 is a perspective view of an electrical insert or sleeve for the housing of a connector device according to an embodiment;

FIG. 9 is a sectional side view of a housing of a connector device according to an embodiment with two electrical cables inserted in a cover and a base and including the electrical insert of FIG. 8;

FIG. 10 is a detail sectional side view indicating electric contacting within the housing of FIG. 6 in a closed state;

FIG. 11 is a detail sectional side view indicating electric contacting within the housing of FIG. 9 in a closed state;

FIG. 12 is a sectional perspective view of a connector device with a housing similar to FIG. 6 in a closed state;

FIG. 13A is a perspective view of reservoirs of grease provided for the cover and the base of a housing of a connector device according to an embodiment;

FIG. 13B is a sectional perspective view of reservoirs of grease provided for the cover and the base of the housing of a connector device according to an embodiment;

FIG. 14A is a sectional perspective view of replacement of air by grease provided by the reservoirs of grease in FIGS. 13A and 13B; and

FIG. 14B is another sectional perspective view of replacement of air by grease provided by the reservoirs of grease in FIGS. 13A and 13B.

### DETAILED DESCRIPTION OF THE EMBODIMENT(S)

Further features and exemplary embodiments as well as advantages of the present disclosure will be explained in detail with respect to the drawings. It is understood that the present disclosure should not be construed as being limited by the description of the following embodiments. It should furthermore be understood that some or all of the features described in the following may also be combined in alternative ways.

The present invention provides a connector device configured for connecting one or more electrical cables. The connector device comprises a housing designed to substantially avoid the occurrence of triple points. In an embodiment, air is removed from interfaces between conductive parts of cables to be connected by the connector device and insulating parts of the connector device in a closed state of a housing of the connector device.

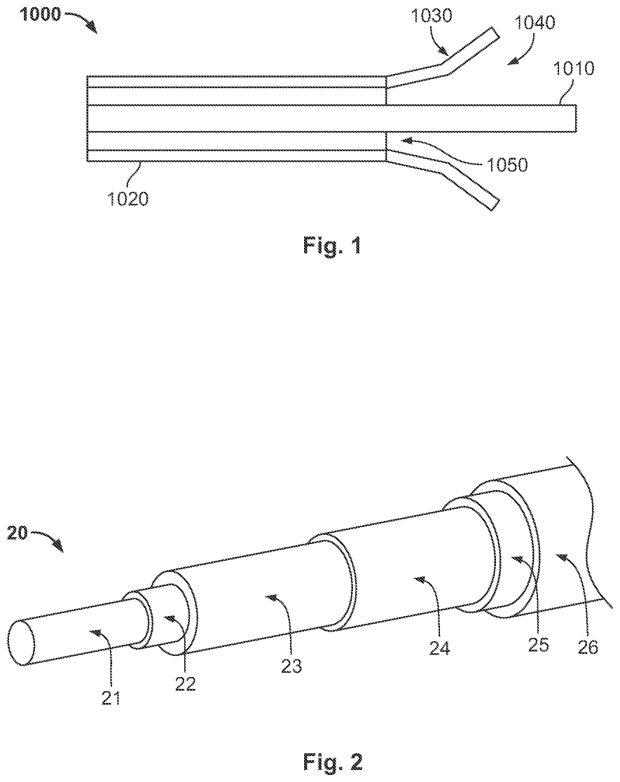

A typical example of an electrical cable that can suitably be connected by a connector device provided herein is shown in FIG. 2. The electrical cable 20 shown in FIG. 2 has an inner connector or connector strands 21 surrounded by a (first, inner) electrically conductive jacket 22 insulated by a dielectric jacket 23. Above the dielectric jacket 23 another (second, outer) electrically conductive jacket 24 is formed. An electrically conductive braid 25 is formed above the other electrically conductive jacket 24 and it is covered by an outer insulating jacket 26. The configuration shown in FIG. 2 allows to avoid triple points within the electrical cable 20. The first (inner) conductive jacket 22 might be not present but in the following description it is assumed that it is present for illustrative purposes. Similarly, the second (outer) conductive jacket 24 may not be present but in the following description it is assumed that it is present for illustrative purposes.

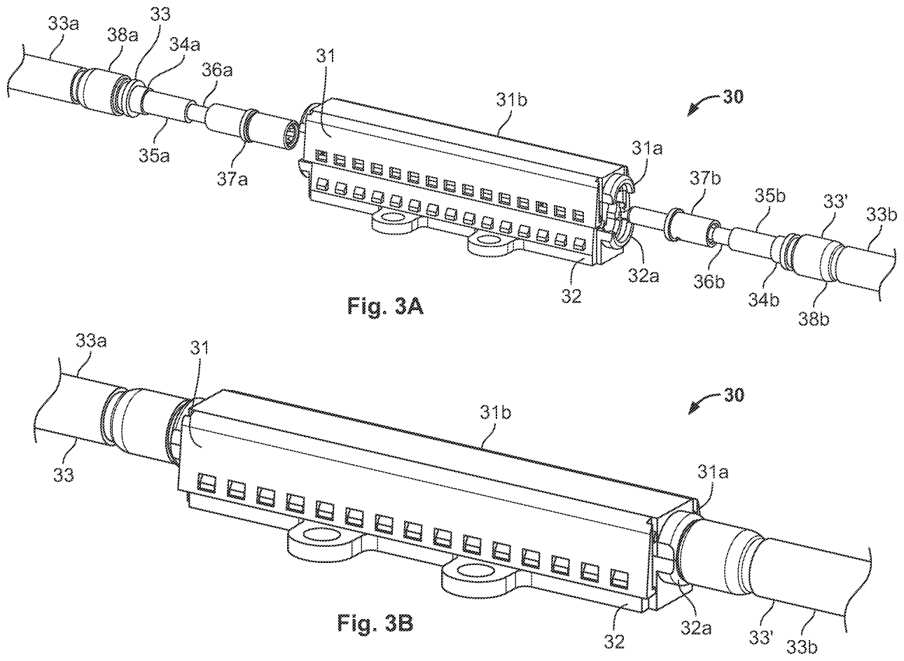

Electrical connector devices provided herein can be configured for connecting one or more electrical cables to one or more other electrical cables or they can be configured as termination connectors, for example. An exemplary jiffy junction connector device 30 is illustrated in FIGS. 3A and 3B. FIG. 3A shows a cover (upper part) 31 of a housing of the connector device 30 and a base (lower part) 32 of the housing of the connector device 30 in an open state before insertion of the electrical cables 33 and 33′ and FIG. 3B shows the cover 31 and the base 32 in a closed state. The housing is closed by pushing the cover 31 and the base 32 to each other. The cover 31 comprises a cover port 31a and the base 32 comprises a base port 32a for receiving electrical cables to be connected with each other by the connector device 30. The cover port 31a, the base port 32a, at least a portion 31b of the upper surface of the cover 31 and at least a portion of the lower surface of the base 32 are electrically conductive for electrically contacting braids 38a, 38b of the cables 33 and 33′.

In the example shown in FIG. 3A, the cable 33 comprising an insulating jacket 33a, a first conductive jacket 34a, a dielectric jacket 35a, a second conductive jacket 36a, a braid 38a and a socket contact 37a and the cable 33′ comprising an insulating jacket 33b, a first conductive jacket 34b, a dielectric jacket 35b, a second conductive jacket 36b, a braid 38b and a pin contact 37b are to be connected with each other by the connector device 30. The socket contact 37a may be crimped to a tip of the electrical cable 33 and the pin contact 37b may be crimped to a tip of the electrical cable 33′. The braid 38a may comprise a notch or flange 38an and the braid 38b may comprise a notch or flange 38bn and the ports 31a, 32a may comprise receptacles for mating the notches or flanges 38an, 38bn of the braids 38a, 38b.

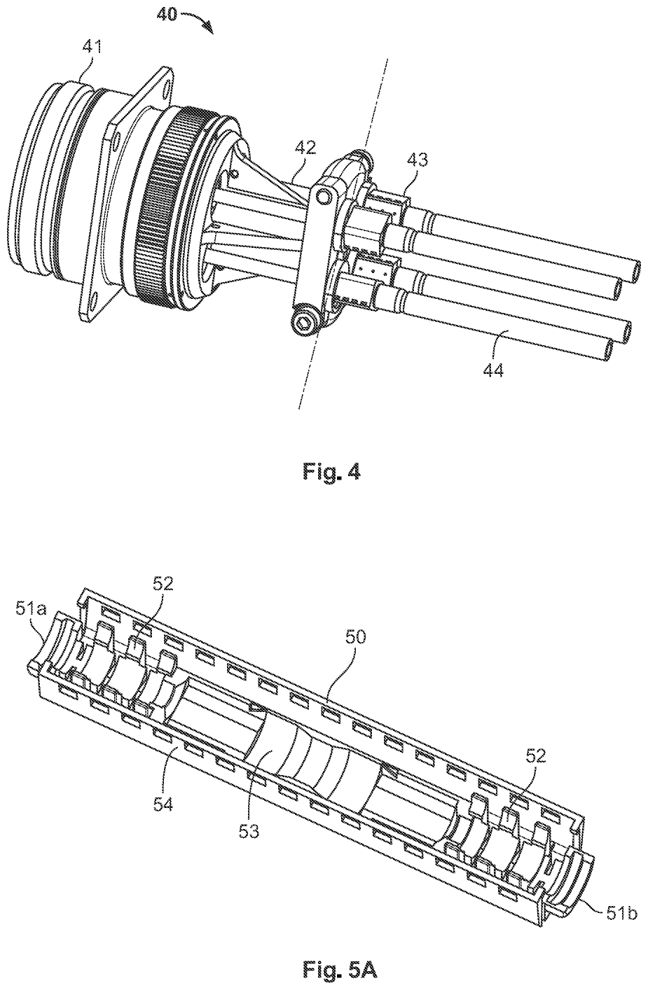

FIG. 4 illustrates a termination connector 40 comprising a backshell on a receptacle 41. The termination connector 40 may provide electrical contact to some appliance, for example, a power source, via conductors/cables 42. The termination connector 40 comprises housings 43 for connecting the backshell conductors/cables 42 with electrical cables 44.

In the following, details of a connector device similar to the connector device 30 shown in FIGS. 3A and 3B and a procedure of connecting two electrical cables with each other by such a connector device are described for illustrative purposes.

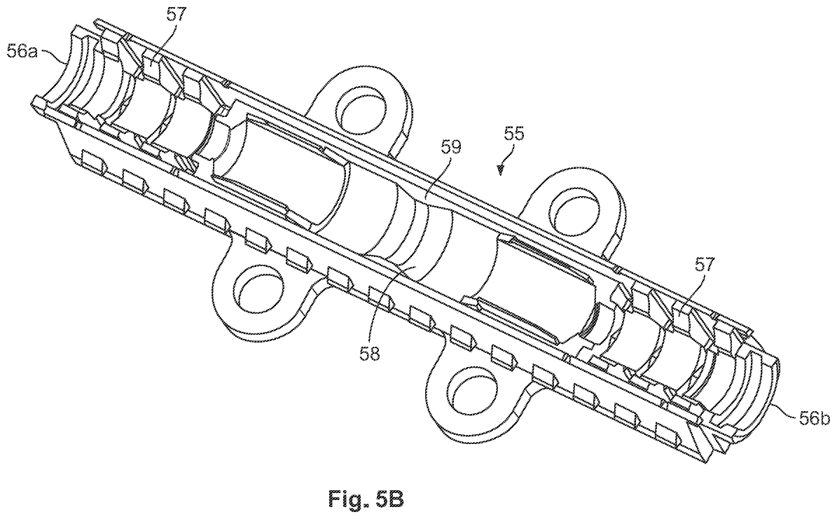

Details of a cover and a base of a particular embodiment of an inventive connector device are shown in FIGS. 5A and 5B. The cover 50 shown in FIG. 5A comprises two electrically conductive cover ports 51a and 51b for contacting braids of electrical cables (cf. also FIG. 3B). Further, the cover 50 comprises cover finger elements 52 for mechanically interacting with the base 55 shown in FIG. 5B. Furthermore, the cover 50 comprises an electrically conductive cover portion 53 (for example, some electrically conductive painting or plating) formed on an inner surface a dielectric cover wall material 54 of the cover 50. The electrically conductive cover portion 53 is configured for electrically contacting conductive portions of electrical cables, for example, (inner) electrically conductive jackets surrounding a central inner conductor or strands, to be connected by the connector device comprising the cover 50. The electrically conductive cover portion 53 may also be referred to as a contacting element herein.

Corresponding to the cover 50 the base 55 shown in FIG. 5B comprises two electrically conductive base ports 56a and 56b for contacting braids of electrical cables. Further, the base 55 comprises base finger elements 57 for mechanically interacting with the finger elements 52 of the cover 50. The cover finger elements 52 and the base finger elements 57 are geometrically complementary to each other.

Furthermore, the base 55 comprises an electrically conductive base portion 58 (for example, some electrically conductive painting or plating) formed on an inner surface a dielectric base wall material 59 of the base 55. It is noted that according to other embodiments rather than the electrically conductive portions 53 and 58 some electrically conductive insert or sleeve for accommodating the end portions of the cables 33 and 33′ may be provided.

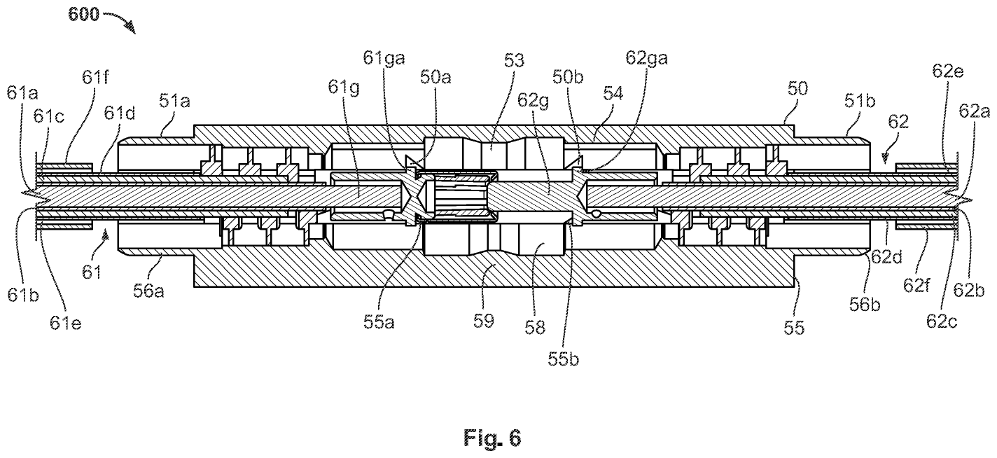

FIG. 6 shows a configuration of a connector device 600 in which two electrical cables 61 and 62 are inserted into the cover 50 and base 55 illustrated in FIGS. 5A and 5B that are already mated to each other but yet not closed to each other. The cable 61 comprises an inner conductor or conductor strands 61a, a (first, inner) conductive jacket 61b, a dielectric jacket 61c, another (a second, outer) conductive jacket 61d, a conductive braid 61e and an insulating jacket 61f. Further, a socket contact 61g is fastened to a tip of the inner conductor 61a. The cable 62 comprises an inner conductor or conductor strands 62a, a (first, inner) conductive jacket 62b, a dielectric jacket 62c, another (a second, outer) conductive jacket 62d, a conductive braid 62e and an insulating jacket 62f. Further, a pin contact 62g is fastened to a tip of the inner conductor 62a. The cables 61 and 62 are inserted into the cover 50 and 55 until a collar 61ga of the socket contact 61g is latched with a cover latching member 50a comprised by the cover 50 and a base latching member 55a comprised by the base 55 and latching of a collar 62g of the pin contact 62g with another cover latching member 50b comprised by the cover 50 and another base latching member 55b comprised by the base 55. In this state, according to the example shown in FIG. 6, the socket contact 61g and the pin contact 62g may be in contact with each other but the pin contact 62g is not yet inserted into the socket contact 61g (this will only result from closing the cover 50 to the base 55 in a later procedural step of the connection procedure). This insertion will only be achieved when closing the cover 50 to the base 55.

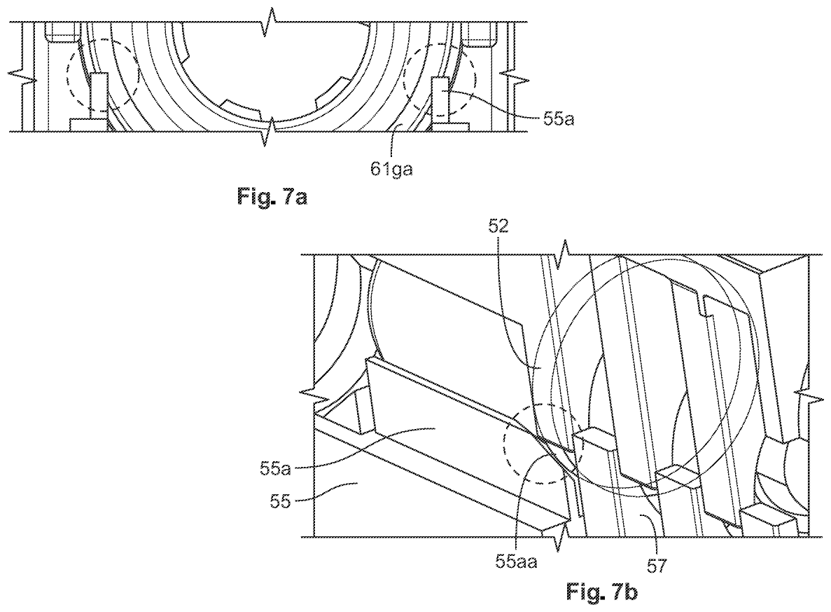

Details related to the latching of the contacts to the latching members are shown in FIGS. 7A and 7B. The collar 61ga of the socket contact 61g abuts the base latching member 55a of the base 55. The base latching member 55a may comprise a chamfered edge 55aa for ease of operation. As can be seen in FIG. 7B the finger elements 52 comprised by the cover 50 and the finger elements 57 comprised by the base 55 may be already in contact with each other but in the state shown in FIGS. 6, 7A and 7B they are not yet interdigitated with each other (this will only result from closing the cover 50 to the base 55 in a later procedural step of the connection procedure).

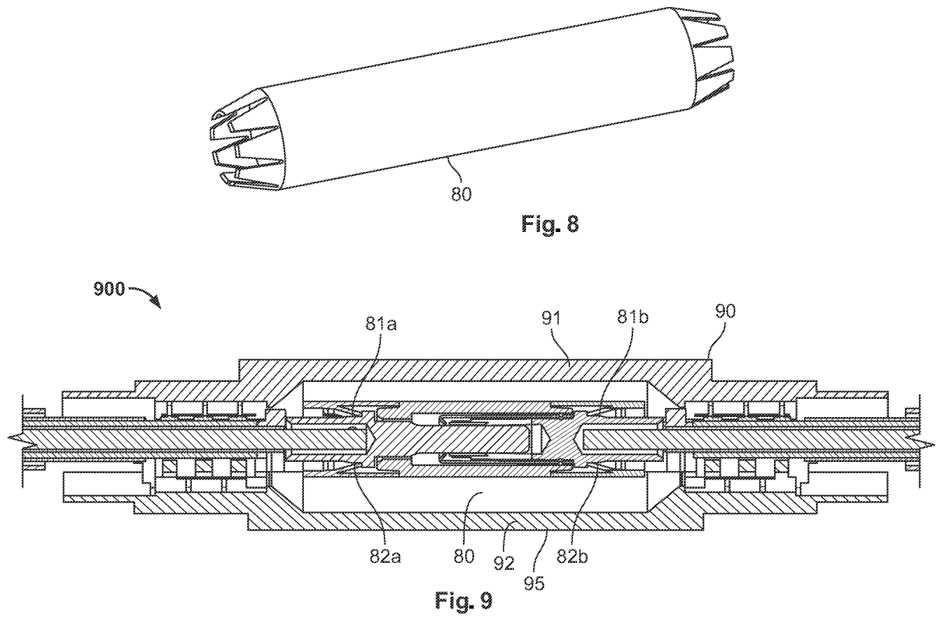

As already noted according to another embodiment, an electrically conductive insert can be provided rather than the electrically conductive portions 53 and 58. FIG. 8 shows an example of such a conductive insert (sleeve) 80 configured for accommodating the end portions of electrical cables to be connected with each other. The conductive insert 80 may be formed integrally as one piece and comprises ports for the insertion of end portions of electrical cables. The conductive insert 80 may also be referred to as a contacting element herein.

FIG. 9 shows a configuration of a connector device 900 making use of the insert 80 shown in FIG. 8. The same electrical cables as described with reference to FIGS. 2 and 6 can be connected with each other by the connector device 900 shown in FIG. 9. The cover 90 of the housing of the connector device 900 comprises a dielectric cover wall material 91 and the base 95 of the housing comprises a dielectric base wall material 92. An outer surface of the cover 90 comprises an electrically conductive portion for electrically contacting the braids of the cables. Electrically contacting the electrically conductive jackets of the electrically cables is provided by the insert 80. Moreover, latching of the collars of the pin and socket contacts is provided by latching members 81a, 81b, 82a and 82b formed inside of the electrically conductive insert 80.

In both the configuration shown in FIG. 6 and the configuration shown in FIG. 9, the housing is closed by pushing the cover 50, 90 and the base 55, 95 to each other. The housings are configured such that, by the closing procedure, electrically conductive portions within the housing (being part of the housing and the electrical cables, respectively) are in contact with each other and, thus, at the same electrical potential. There is substantially no air (i.e. gas-free) between the electrically conductive parts and the dielectric wall material of the cover and base.

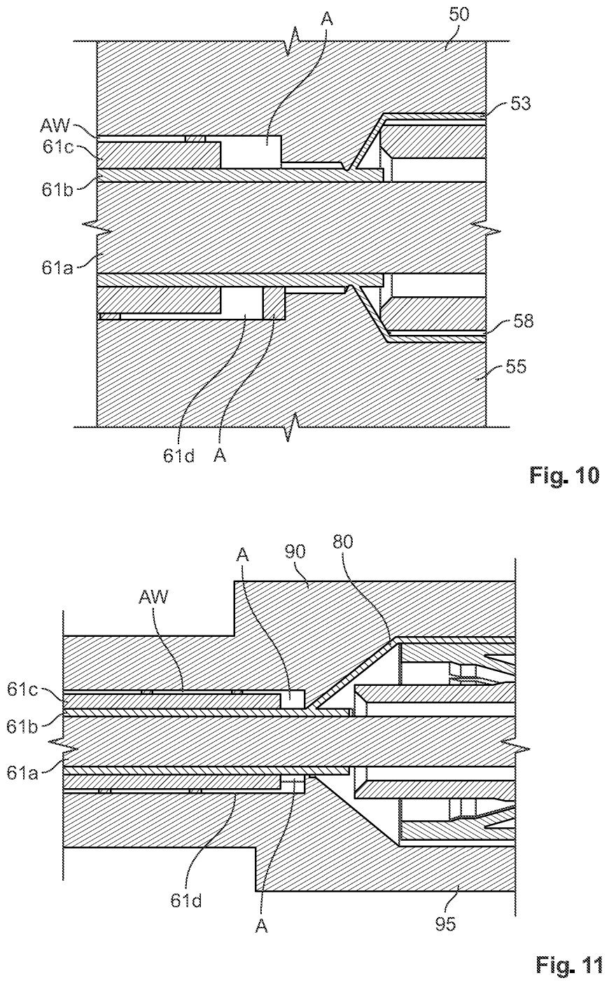

FIG. 10 shows the electrical contacting within the closed housing for the configuration illustrated in FIG. 6 and FIG. 11 shows the electrical contacting within the closed housing for the configuration illustrated in FIG. 9. As shown in FIG. 10, the conductive jacket 61b in the closed state of the housing is in contact (engaged) with the electrically conducting portion 53 of the cover 50 and the electrically conducting portion 58 of the base 55 with no air between the electric potential and the dielectric materials of the cover 50 and the base 55 Similarly, FIG. 11 shows the conductive jacket 61b in the closed state of the housing being in contact (engaged) with the electrically conducting insert 80 with no air between the electric potential and the dielectric materials of the cover 90 and the base 95.

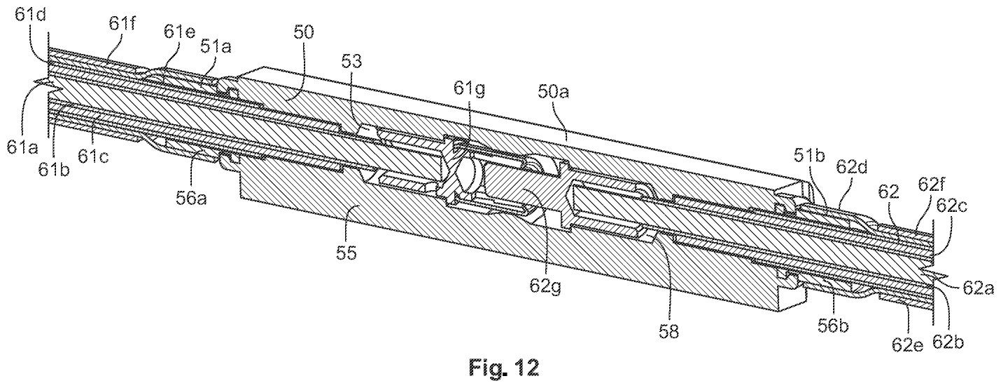

FIG. 12 shows an exemplary embodiment of a connector device with a housing similar to the one shown in FIG. 6 in a closed state. In the closed state, the pin contact 62g is at least partially or completely inserted into the socket contact 61g. All of the inner conductor 61a, the first conductive jacket 61b, the socket contact 61g, the inner conductor 62a, the first conductive jacket 62b, the socket contact 62g and the conductive portion 53 of the cover 50 as well as the conductive portion 58 of the base 55 are at the same first electrical potential in the closed state of the housing. On the other hand, all of the braid 61e, the braid 62e, the port 51a, the port 51b, the port 56a, the port 56b, the outer conductive portion 50a of the cover and the outer conductive portion (not shown in FIG. 11) of the base 55 are at the same second electrical potential different from the first electrical potential with substantially no air present between all of the first and second electrical potentials and dielectric materials such that triple points can be avoided.

It is noted that all of the above-described embodiments also work for connecting electrical cables that do not comprise first (inner) conductive jackets surrounding inner conductors (strands). In this case, the inner conductors and the conductive inner portions of the covers and bases are electrically contacted with each other (and, thus, brought to the same electrical potential) via the pin and socket contacts only.

However, even when designing the cover and base of a connector to avoid air between electrical potentials and dielectric materials still some cavities may be built wherein some air might be trapped and fluid connection between air and potentials might arise. This can be seen, for example, in the configurations shown in FIGS. 10 and 11. Some air might be trapped in an air cavity A between the conductive jacket 61b (or if not present the inner conductor 61a), the dielectric jacket 61c and the (dielectric material of the) cover 50 as well as between the conductive jacket 61b (or if not present the inner conductor 61a), the dielectric jacket 61c and the (dielectric material of the) base 55. This air might be in fluid communication directly with the second conductive jacket 61d or via an airway AW unintentionally formed between the dielectric jacket 61c and the dielectric wall material of the cover and/or the base thereby possible giving rise to the formation of a triple point. In order to avoid the formation of triple points in that manner, according to embodiments, some grease material is provided for the cover 50 and/or base 55 in the configuration shown in FIGS. 6, 10, 11 and 12. Such a grease material can be provided for any configuration provided herein. Reservoirs of grease can be arranged at suitable position in the cover and/or base of the housing and can be suitably distributed/dispensed during the closing of the housing in order to avoid air cavities like the air cavities A shown in FIGS. 10 and 11.

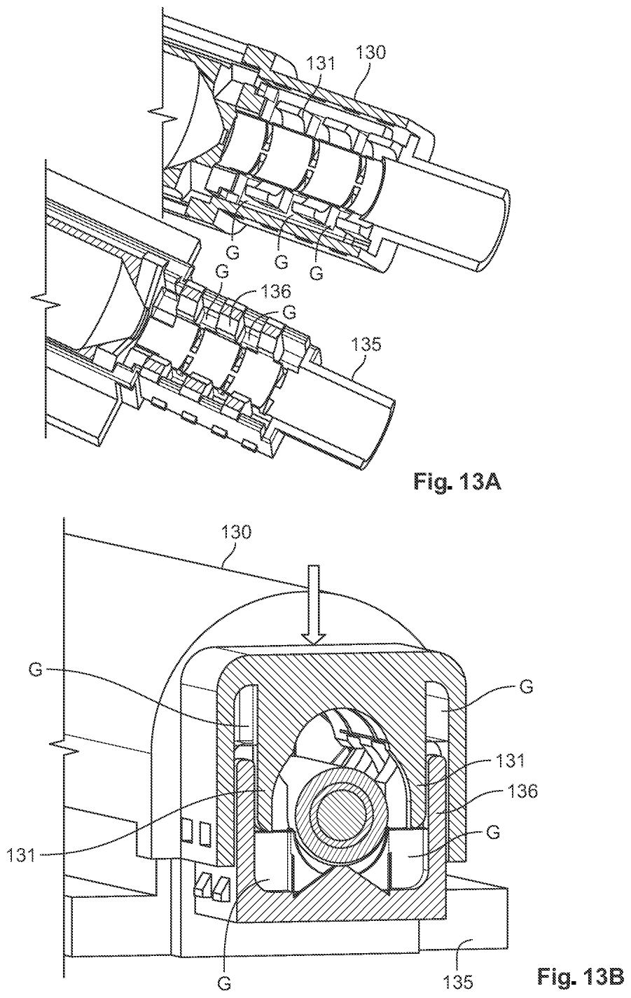

FIG. 13A shows a cover 130 of a housing of a connector device according to an embodiment and, correspondingly, a base 135 of a housing of a connector device according to an embodiment. The cover 130 comprises finger elements 131 and the base 135 also comprises complementary finger elements 136. Reservoirs of grease R are arranged between the finger elements 131 and 136, respectively. FIG. 13B shows a housing comprising the cover 130 and base 135 shown in FIG. 13A in a mated but not yet closed state. When the housing is closed by pushing the cover 130 towards the base 135 (indicated by the arrow in FIG. 13B) the respective finger elements 131 and 136 are pushed onto the respective reservoirs of grease R.

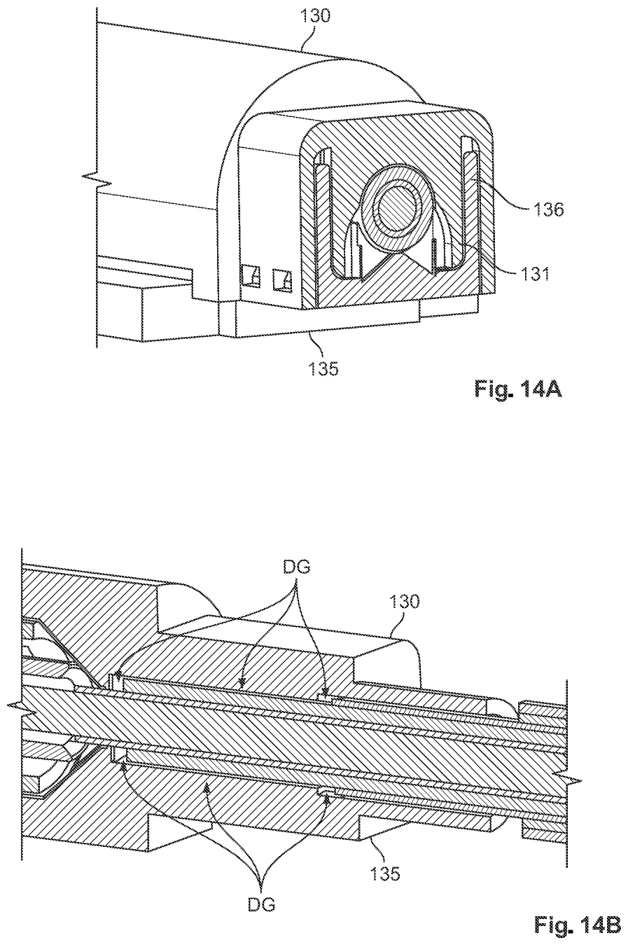

When the housing is closed the grease is pushed out of the reservoirs shown in FIGS. 13A and 13B and distributed into air cavities that might be present as it is illustrated in FIGS. 14A and 14B. The dispensed grease DG pushes out air between the dielectric material of the housing and the conductive portions of the electrical cable. Particularly, by the action of the finger elements 131 and 136 on the reservoirs R, the air cavities A formed between electrical potentials and dielectric materials of the cover and base as shown in FIGS. 10 and 11 can be filled by grease in the closed state of the housing (see FIG. 14B).

All of the above-described embodiments allow for a quick and easy connection of electrical cables substantially without significantly causing the formation of triple points.

What is claimed is:

1. A connector device for connecting a cable, comprising:
a housing having a cover formed of a dielectric cover wall material and a base formed of a dielectric base wall material, the cover and the base are mated in a closed state of the housing and receive an end portion of the cable that has an electrically conductive portion; and
a contacting element electrically contacting the electrically conductive portion of the cable in the closed state of the housing, the housing is substantially gas-free in the closed state between:
the electrically conductive portion of the cable and the dielectric cover wall material;
the electrically conductive portion of the cable and the dielectric base wall material;
the contacting element and the dielectric cover wall material; and
the contacting element and the dielectric base wall material.

2. The connector device of claim 1, wherein the contacting element engages a contact of the cable.

3. The connector device of claim 1, wherein the contacting element electrically contacts in the closed state an electrically conductive jacket of the cable that surrounds an inner conductor of the cable.

4. The connector device of claim 3, wherein, in the closed state of the housing, the housing is substantially gas-free between the electrically conductive jacket and the dielectric cover wall material, and between the electrically conductive jacket and the dielectric base wall material.

5. The connector device of claim 1, wherein the housing has a plurality of reservoirs of a dielectric grease material provided in the housing.

6. The connector device of claim 5, wherein, in the closed state of the housing, the dielectric grease material is dispersed into a plurality of air cavities formed before reaching the closed state between:
the electrically conductive portion of the cable and the dielectric cover wall material; and/or
the electrically conductive portion of the cable and the dielectric base wall material.

7. The connector device of claim 1, wherein the cover has a plurality of first finger elements and the base has a plurality of second finger elements, the first finger elements engage the second finger elements in the closed state of the housing.

8. The connector device of claim 7, wherein the housing has a plurality of reservoirs of a dielectric grease material provided in the housing, the reservoirs are arranged between at least some of the first finger elements and/or at least some of the second finger elements.

9. The connector device of claim 8, wherein, in the closed state of the housing, at least some of the first finger elements and/or the second finger elements push the dielectric grease into a plurality of air cavities of the housing formed before reaching the closed state.

10. The connector device of claim 1, wherein the contacting element is:
an electrically conductive area formed on an inner surface of the dielectric cover wall material and the dielectric base wall material; or
an electrically conductive insert arranged between the cover and the base.

11. The connector device of claim 10, wherein the contacting element is the electrically conductive insert and accommodates a tip of the end portion of the cable.

12. The connector device of claim 1, wherein the housing has a first port receiving a first electrical cable and a second port different from the first port receiving a second electrical cable different from the first electrical cable.

13. The connector device of claim 1, wherein the cover has an electrically conductive cover portion formed over or in the dielectric cover wall material and facing exclusively an outside of the cover.

14. The connector device of claim 13, wherein the base has an electrically conductive base portion formed over or in the dielectric base wall material and facing exclusively an outside of the base.

15. A system, comprising:
an electrical cable having an end portion that has an electrically conductive portion; and
a connector device including a housing and a contacting element electrically contacting the end portion of the electrical cable in a closed state of the housing, the housing has a cover formed of a dielectric cover wall material and a base formed of a dielectric base wall material, the cover and the base are mated in the closed state of the housing and receive the end portion of the cable, the housing is substantially gas-free in the closed state between:
the electrically conductive portion of the cable and the dielectric cover wall material;
the electrically conductive portion of the cable and the dielectric base wall material;
the contacting element and the dielectric cover wall material; and
the contacting element and the dielectric base wall material.

16. The system of claim 15, wherein the electrically conductive portion of the electrical cable is at least one of an inner conductor, an electrically conductive jacket surrounding the inner conductor, and a contact fastened to a tip of the inner conductor.

17. The system of claim 15, wherein the electrical cable has an electrically conductive braid formed over an inner conductor of the electrical cable and electrically connected with an electrically conductive cover portion of the cover and an electrically conductive base portion of the base in the closed state.

18. The system of claim 17, wherein the electrically conductive cover portion is formed over or in the dielectric cover wall material and faces exclusively an outside of the cover, and the electrically conductive base portion is formed over or in the dielectric base wall material and faces exclusively an outside of the base.

19. The system of claim 17, wherein the electrically conductive braid has a notch or a flange and the housing has a port receiving the electrical cable, the port has a receptacle mating with the notch or the flange.

20. A method of connecting an electrical cable to a connector device, comprising:
providing a cover of a housing of the connector device and a base of the housing, the cover is formed of a dielectric cover wall material and the base is formed of a dielectric base wall material, the housing has a contacting element;
inserting the electrical cable between the cover and the base;
closing the housing by pushing the cover and the base towards each other, the housing is substantially gas-free in the closed state between:
the electrically conductive portion of the cable and the dielectric cover wall material;
the electrically conductive portion of the cable and the dielectric base wall material;
the contacting element and the dielectric cover wall material; and
the contacting element and the dielectric base wall material; and
electrically connecting the contacting element and the electrically conductive portion by closing the housing.
